(19) United States
(12) Patent Application Publication
(10) Pub. No.: US 2025/0120347 A1
(43) Pub. Date: Apr. 17, 2025

(54) CROP CULTIVATION APPARATUS EQUIPPED WITH CRANE FOR MOVING CULTIVATION MODULES

(71) Applicant: AG-UNI Co.,Ltd, Gyeongsan-si (KR)

(72) Inventor: MIJIN GWON, Gyeongsan-si (KR)

(21) Appl. No.: 18/523,215

(22) Filed: Nov. 29, 2023

(30) Foreign Application Priority Data
Oct. 13, 2023 (KR) 10-2023-0136758

(51) Int. Cl. A01G 9/14; A01G 9/02

(52) U.S. Cl. CPC A01G 9/143; A01G 9/022

(57) ABSTRACT

A crop cultivation apparatus includes: a shelf case composed of one or more layers, extending to one side, and provided with loading spaces formed in the respective layers; one or more stackable accommodation parts disposed in each of the loading spaces of the shelf case, and configured to provide a first cultivation space, and arranged to be stackable in the vertical direction; a support part seated on the shelf case, and configured to allow the stackable accommodation parts to be seated thereon and to provide a second space from which a nutrient solution is discharged and to which air is supplied; and a crane disposed in front of the shelf case, and configured to transfer each of the stackable accommodation part; wherein the crane transfers the stackable accommodation part after separating the stackable accommodation part from the loading space.

### CROSS-REFERENCE TO RELATED APPLICATION

This application claims the benefit of Korean Patent Application No. 10-2023-0136758 filed on Oct. 13, 2023, which is hereby incorporated by reference herein in its entirety.

### BACKGROUND

### 1. Technical Field

The present invention relates to a crop cultivation apparatus that utilizes a crane to efficiently transfer cultivation modules loaded onto a shelf case.

### 2. Description of the Related Art

As living spaces and farmland are becoming narrower due to population growth and industrialization, efforts to cultivate a large quantity of flowers and vegetables in a small area are being carried out in various fields. Furthermore, as the residential form in large cities is converted from single and multi-family houses to apartments, there are a growing number of people who feel like being in the garden of a detached house and utilize plant cultivation for hobbies or decoration by cultivating plants such as flowering plants and flowers on the veranda of an apartment house or in the inside of a building.

In general, to cultivate plants on the veranda of an apartment house or in the inside of a building, there is a method of cultivating plants in a cultivation box. Since a common cultivation box is intended to be installed on the ground, there is a problem in that a large cultivation space is unnecessarily occupied and thus space utilization is inefficient. Furthermore, when the space of the veranda of an apartment house or the inside of a building is narrow, the number of plants that can be cultivated is limited.

In order to overcome these problems, a plant cultivation apparatus in which a plurality of flowerpots are vertically stacked on top of each other or are arranged in a horizontal space has been developed. However, this conventional plant cultivation apparatus has disadvantages in that the spaces between flowerpots cannot be utilized and it is inconvenient to take out plants planted in flowerpots and plant new plants.

In particular, when pots or cultivation modules for crop cultivation are stacked on top of each other vertically as in a shelf case, a problem arises in that a user needs to transfer cultivation modules one by one by hand, so that there is a problem in that it takes a long time to transfer crops.

Furthermore, users often use ladders in the process of manually transferring or harvesting crops. In these cases, there are problems in that safety-related accidents may occur during a work process and it is cumbersome for users to move when a problem occurs with crops or the apparatus.

Related art literature for the conventional crop cultivation apparatus is as follows:
Patent document: Korean Patent No. 10-2012-0007420 entitled “Stacked Drawer-type Plant Cultivation Apparatus”

### SUMMARY

The present invention has been conceived to overcome the above-described problems, and an object of the present invention is to provide a crop cultivation device equipped with a crane that can efficiently transfer cultivation modules loaded onto a shelf case.

According to an aspect of the present invention, there is provided a crop cultivation apparatus including: a shelf case composed of one or more layers, extending to one side, and provided with loading spaces formed in the respective layers; one or more stackable accommodation parts disposed in each of the loading spaces of the shelf case, and configured to provide a first cultivation space for cultivating soil crops therein, and arranged to be stackable in the vertical direction; a support part seated on the shelf case, and configured to allow the stackable accommodation parts to be seated thereon and to provide a second space from which a nutrient solution is discharged and to which air is supplied; and a crane disposed in front of the shelf case, and configured to transfer each of the stackable accommodation part; wherein the crane transfers the stackable accommodation part in vertical and horizontal directions after separating the stackable accommodation part from the loading space.

The crane may include: a horizontal part extending in the direction in which the shelf case extends, and configured to generate horizontal power and to horizontally transfer the stackable accommodation part; a vertical part extending upward from the horizontal part, and configured to generate vertical power and to vertically transfer the stackable accommodation part; and a transfer part disposed on the vertical part, and configured to generate transfer power and to separate the stackable accommodation part from the loading space; the vertical part may be horizontally movable along the direction in which the horizontal part extends; and the transfer part may be vertically movable along the direction in which the vertical part extends.

The horizontal part may include: a horizontal rail extending to both sides, and configured to guide horizontal movement in the horizontal direction; a horizontal shaft disposed on the central side of the horizontal rail along the direction in which the horizontal rail extends, and provided with threads formed on the outside thereof; a horizontal power unit configured to provide horizontal power to rotate the horizontal shaft; and a horizontal transfer part provided with threads that correspond to the threads of the horizontal shaft and are formed on the inside thereof, coupled to the horizontal shaft, and configured to allow the vertical part to be disposed on the top thereof; and the horizontal part may be disposed such that, when the horizontal power is provided, the vertical part is moved in the horizontal direction while the horizontal transfer part is moved in the horizontal direction along the direction in which the horizontal rail extends by the rotation of the horizontal shaft.

The vertical part may include: a vertical rail extending vertically, and configured to guide vertical movement in the horizontal direction; a vertical shaft disposed on one side of the vertical rail along the direction in which the vertical rail extends, and provided with threads formed the outside thereof; a vertical power unit configured to provide vertical power to rotate the vertical shaft; and a vertical transfer part provided with threads that correspond to the threads of the vertical shaft and are formed on the inside thereof, coupled to the vertical shaft, and configured to allow the transfer unit to be coupled to one side thereof; and the vertical part may be disposed such that, when the vertical power is provided, the transfer part is moved up and down in the vertical direction while the vertical transfer part is moved vertically in the direction in which the vertical rail extends by the rotation of the vertical shaft.

The transfer part may include: a base part coupled to the vertical part, and configured to provide a support space for supporting the stackable accommodation part; transfer rails disposed on both sides of the base part, extending to one side, and configured to guide the stackable accommodation part in a separation direction; transfer supports disposed on the transfer rails, disposed to be movable to one side or the other side along the direction in which the transfer rails extend, and configured to support both sides of the stackable accommodation part on the tops thereof and to transfer the stackable accommodation part; a transfer power unit configured to provide transfer power to move the transfer supports; and a transfer power transmission part configured to transmit the transfer power, generated by the transfer power unit, to the transfer supports.

The transfer supports may include: first transfer supports disposed on the tops of the transfer rails; and second transfer supports disposed on the bottoms of the transfer rails, and coupled to the top surface of the base part.

The transfer power transmission part may include: transfer gears provided with gear teeth formed on the outer peripheral surfaces thereof that engage with gear teeth formed on the inner surfaces of the first and second transfer supports; and a transfer shaft formed in a shaft form that connects the centers of the transfer gears to each other; and, when the transfer power unit generates transfer power, all the transfer gears may be rotated by the transfer shaft.

The crop cultivation apparatus may further include a control unit configured to control the horizontal part, the vertical part, and the transfer part; and set coordinates may be stored for each disposition position of each stackable accommodation part in the loading space, and, when a user inputs a control signal, the control unit may control the vertical part, the horizontal part, and the transfer part so that the stackable accommodation part can be transferred to a location corresponding to set coordinates that match the control signal.

The above-described crop cultivation apparatus equipped with a crane for moving cultivation modules according to an embodiment of the present invention has the following effects:

First, only the stackable accommodation part of the cultivation module placed in the crop cultivation apparatus may be transferred to the outside, so that there is the effect in which the stackable accommodation part can be easily transferred to the outside without interference with the separate solution supply line, the separate solution discharge line, and the separate air supply line that are fixed to the shelf case.

In particular, only the stackable accommodation part where crops are grown at the desired location may be transferred to the outside using the crane without the need for a grower or harvester to manually climb up and down the shelf case using a ladder. Accordingly, there are the effects in which a high economic advantage is achieved due to a reduction in labor cost and safety-related accidents that may occur depending on a working environment are drastically decreased.

Furthermore, when there is a problem with the solution supply line, the solution discharge line, or the air supply line connected to the shelf case and thus the crops placed on a shelf need to be transferred to another shelf, the stackable accommodation part of the cultivation module may be easily transferred to the other shelf, so that there is the effect in which work time is drastically reduced.

Moreover, the horizontal part of the crane may be extended up to a processing line for harvesting and processing crops, and thus the harvesting and processing of crops may be performed in one stop, so that there are the effects in which harvest efficiency is improved and an overall process spanning from the cultivation of crops through the harvesting thereof to processing thereof is automated in one process.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a perspective view showing the overall configuration of a crop cultivation apparatus according to an embodiment of the present invention;

FIG. 2 is a diagram showing a configuration in which a cultivation module is installed on a shelf of the crop cultivation apparatus according to the embodiment of the present invention;

FIG. 3 is an exploded view of a cultivation module of the crop cultivation apparatus according to the embodiment of the present invention;

FIG. 4 is a semi-see-through view of the cultivation module of the crop cultivation apparatus according to the embodiment of the present invention;

FIG. 5 is a diagram showing the support part of a cultivation module of the crop cultivation apparatus according to the embodiment of the present invention;

FIG. 6 is a diagram showing the stackable accommodation part of the cultivation module of the crop cultivation apparatus according to the embodiment of the present invention;

FIG. 7 is a diagram showing a configuration in which the stackable accommodation parts of cultivation modules of the crop cultivation apparatus according to the embodiment of the present invention are stacked on top of each other;

FIG. 8 is a diagram showing a configuration in which the stackable accommodation parts of cultivation modules of the crop cultivation apparatus according to the embodiment of the present invention are stacked on top of each other and thus a case portion and a coupling portion are coupled to each other;

FIG. 9 is a perspective view showing the crane of the crop cultivation apparatus according to the embodiment of the present invention;

FIG. 10 is a view showing the operation of the horizontal part of the crane of the crop cultivation apparatus according to the embodiment of the present invention;

FIG. 11 is a view showing the operation of the vertical part of the crane of the crop cultivation apparatus according to the embodiment of the present invention;

FIG. 12 is a perspective view showing the transfer part of the crane of the crop cultivation apparatus according to the embodiment of the present invention from one side;

FIG. 13 is a perspective view showing the transfer part of the crane of the crop cultivation apparatus according to the embodiment of the present invention from the other side;

FIG. 14 is a view showing the principle by which the transfer supports of the transfer part of the crane of the crop cultivation apparatus according to the embodiment of the present invention are operated;

FIG. 15 is a view showing the operation of the crane based on shelf cases in the crop cultivation apparatus according to the embodiment of the present invention; and

FIG. 16 is a diagram showing a process in which the transfer part of the crane transfers a stackable accommodation part placed in a loading space of the crop cultivation apparatus according to the embodiment of the present invention.

### DETAILED DESCRIPTION

Embodiments of the present invention will be described in detail below with reference to the accompanying drawings so that those of ordinary skill in the art to which the present invention pertains can easily implement the present invention. The present invention may be implemented in many different forms and is not limited to the structures or methods described herein.

An embodiment of the present invention relates to a crop cultivation apparatus equipped with stackable cultivation modules 200 that can adjust the size of a cultivation space in a stacked manner according to the root length of soil crops. Hereinafter, this apparatus will be briefly described as the “crop cultivation apparatus.”

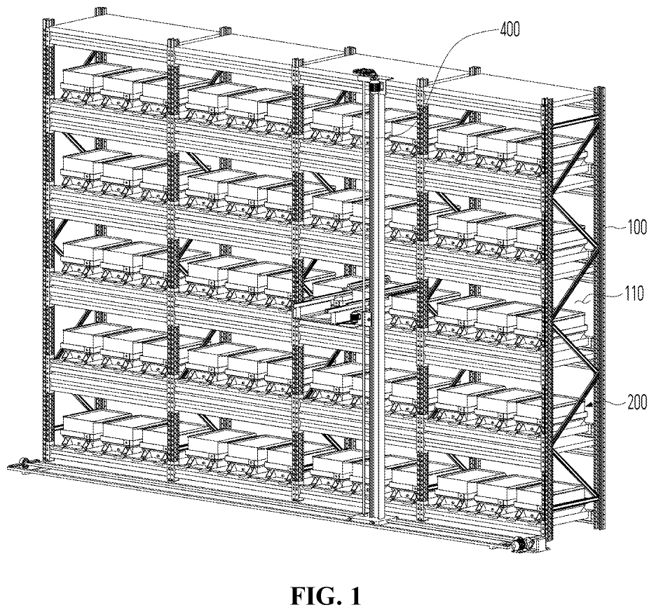

Furthermore, in the detailed description of the present invention, based on FIG. 1, the direction from a shelf case 100 to a crane 400 is defined as the direction toward one side, the direction from the crane 400 to the shelf case 100 is defined as the direction toward the other side, the upward direction from the ground is defined as the upward direction, and the downward direction from the ground is defined as the downward direction, and the direction toward both sides of each of the cultivation modules 200 is defined as the lateral direction. However, it should be noted that these directions are intended merely for ease of description and the directions of the present invention are not limited thereto.

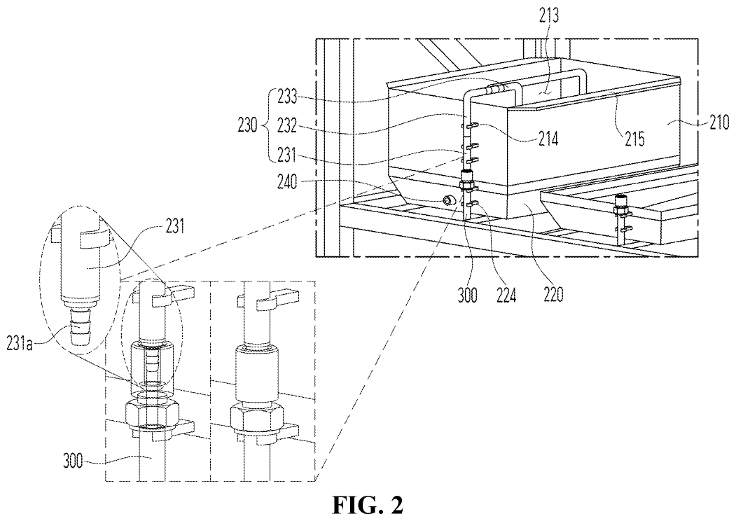

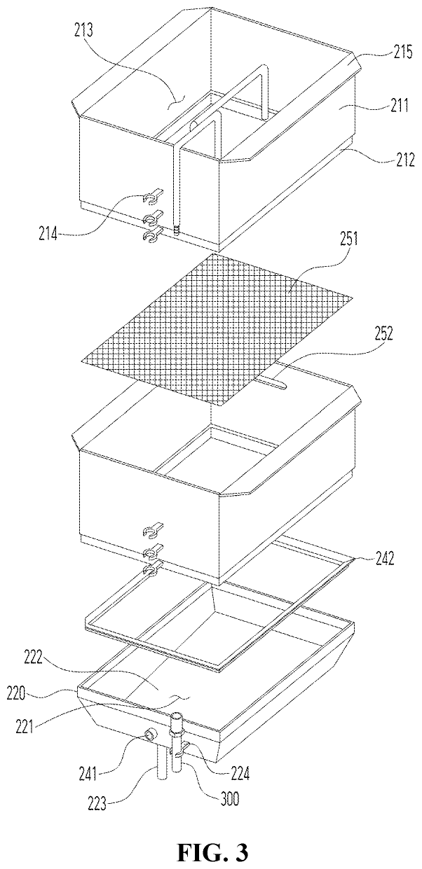

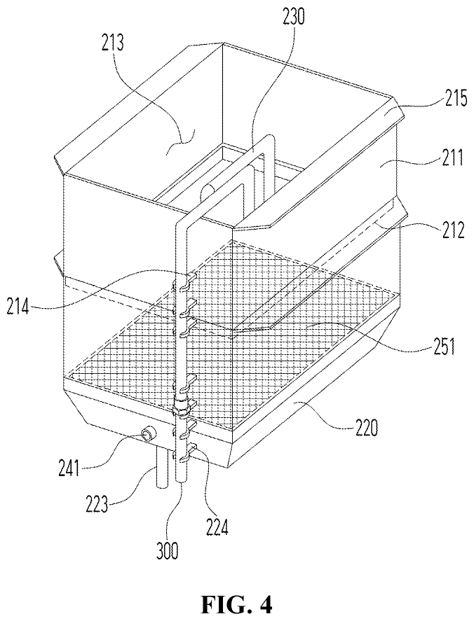

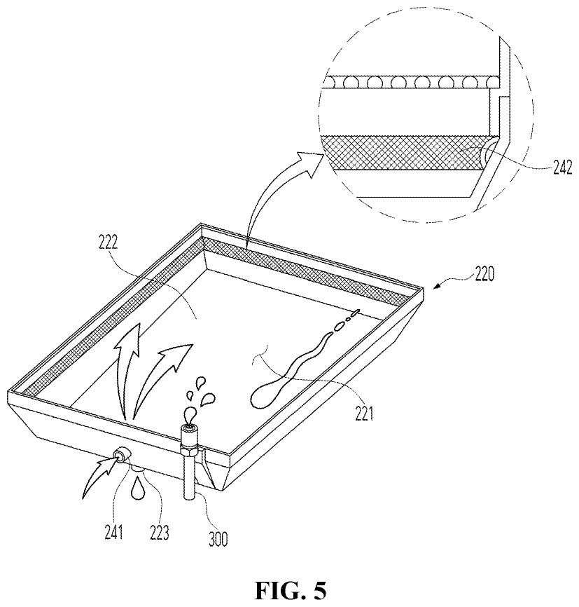

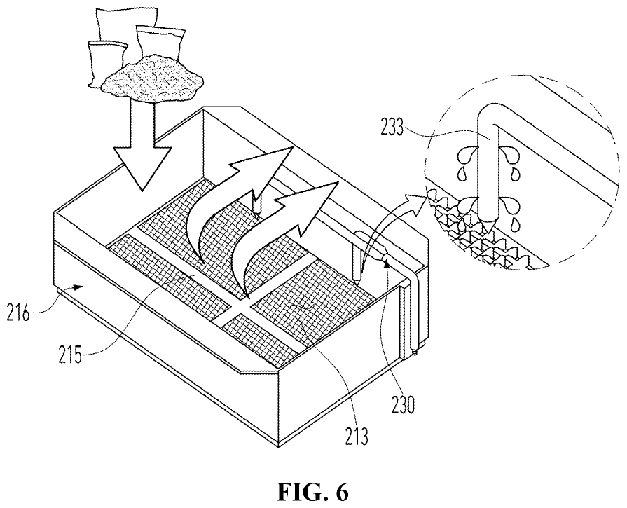

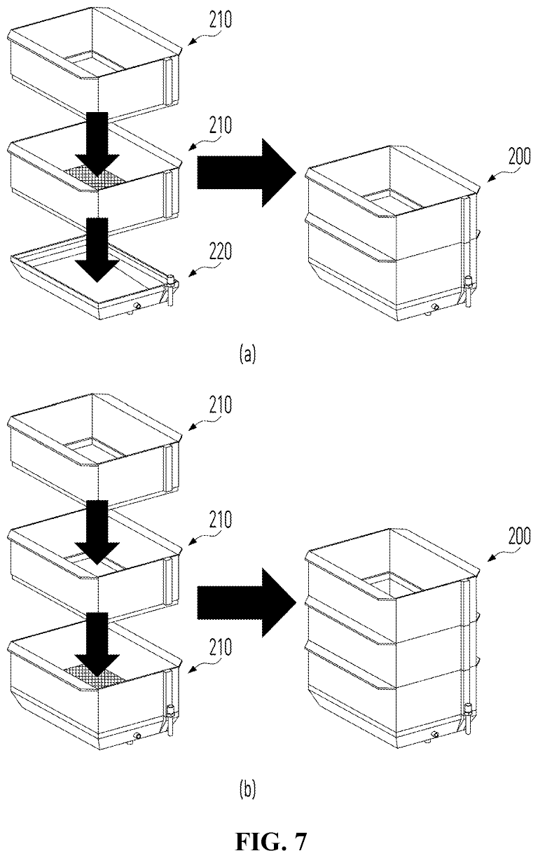

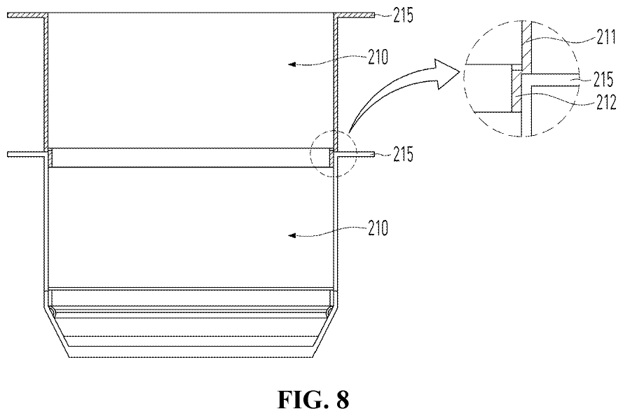

FIG. 1 is a perspective view showing the overall configuration of a crop cultivation apparatus according to an embodiment of the present invention, FIG. 2 is a diagram showing a configuration in which a cultivation module is installed on a shelf of the crop cultivation apparatus according to the embodiment of the present invention, FIG. 3 is an exploded view of a cultivation module of the crop cultivation apparatus according to the embodiment of the present invention, FIG. 4 is a semi-see-through view of the cultivation module of the crop cultivation apparatus according to the embodiment of the present invention, FIG. 5 is a diagram showing the support part of a cultivation module of the crop cultivation apparatus according to the embodiment of the present invention, FIG. 6 is a diagram showing the stackable accommodation part of the cultivation module of the crop cultivation apparatus according to the embodiment of the present invention, FIG. 7 is a diagram showing a configuration in which the stackable accommodation parts of cultivation modules of the crop cultivation apparatus according to the embodiment of the present invention are stacked on top of each other, and FIG. 8 is a diagram showing a configuration in which the stackable accommodation parts of cultivation modules of the crop cultivation apparatus according to the embodiment of the present invention are stacked on top of each other and thus a case portion and a coupling portion are coupled to each other.

Referring to FIGS. 1 to 8, the crop cultivation apparatus equipped with stackable cultivation modules according to the embodiment of the present invention may include: a shelf case 100 composed of one or more layers, and provided with loading spaces 110 in the respective layers; one or more cultivation modules 200 disposed in the loading spaces 110 of the shelf case 100, and configured to provide respective cultivation spaces for cultivating soil crops therein and to have an adjustable height; a solution supply line 300 extending from a nutrient solution supply unit for supplying a nutrient solution to the individual layers of the shelf case 100, and connected to the cultivation modules 200; a solution discharge line extending from a nutrient solution discharge unit for discharging a supplied nutrient solution to the individual layers of the shelf case 100, and connected to the cultivation modules 200; and a crane 400 configured to transfer the cultivation modules 200 from the shelf case 100.

Furthermore, the crop cultivation apparatus equipped with stackable cultivation modules according to the embodiment of the present invention may further include an air supply line extending from an air supply unit to the individual layers of the shelf case 100 and connected to the cultivation modules 200 in order to supply air (oxygen).

The shelf case 100 may extend upward to have one or more layers, preferably two or more layers, and loading spaces 110 may be formed in the respective layers. In this case, as the height of the cultivation modules 200 is adjusted, the loading spaces 110 of the shelf case 100 may be designed and set to a height desired by a user, and there is no limitation to the heights of the loading spaces 110.

The solution supply line 300 is a means that is arranged to branch from the nutrient solution supply unit where the nutrient solution is stored to the individual cultivation modules 200 arranged in the individual layers of the shelf case 100, more specifically the loading spaces 110, and provides a flow path for supplying a nutrient solution to the cultivation spaces formed in the cultivation modules 200. This solution supply line 300 may be branched from the nutrient solution supply unit to the individual layers of the shelf case 100, and may be branched again to the individual cultivation modules 200 in each of the layers. In this case, the solution supply line 300 may move a nutrient solution in the direction from the nutrient solution supply unit to the cultivation modules 200 in order to supply the nutrient solution to the cultivation spaces.

The solution discharge line is a means that provides a flow path for merging and discharging a discharged nutrient solution into the nutrient solution discharge unit for storing and processing a nutrient solution when the nutrient solution supplied to the individual cultivation modules 200 is discharged to the cultivation spaces. In more detail, the solution discharge line may branch from the nutrient solution discharge unit to the individual layers of the shelf case 100, and may branch again to the individual cultivation modules 200 in each of the layers. However, the solution discharge line is a line for discharging a nutrient solution, so that the direction in which a nutrient solution is discharged may be the direction from the cultivation modules 200 to the nutrient solution discharge unit.

The air supply line is a means that is arranged to branch such that air can be supplied from the air supply unit for blowing air or discharging air using air pressure difference to the individual cultivation modules 200 arranged in the individual layers of the shelf case 100, more specifically the loading spaces 110, and provides a flow path for supplying air to the cultivation spaces formed in the respective cultivation modules 200, more specifically the soil inserted into the cultivation spaces. This air supply line may branch from the air supply unit to the individual layers of the shelf case 100, and may branch again to the individual cultivation modules 200 in each of the layers. In this case, the air supply line may move air in the direction from the air supply unit to the cultivation modules 200 to supply the air to the cultivation spaces.

Next, the detailed structure of each of the cultivation modules 200 will be described in detail. The cultivation module 200 of the present invention is a modular means that provides a cultivation space where soil and crops can be planted to cultivate soil crops therein, and at the same time, may adjust the height of the cultivation space as needed.

In more detail, the cultivation module 200 may include: a stackable accommodation part 210 formed in a box shape with an open top and bottom, provided with a first space 213 for planting soil and crops inside, and arranged to be stackable on top of another stackable accommodation portion in the vertical direction; a support part 220 formed in a box shape with an open top, coupled to the bottom of the stackable accommodation part 210 on the lowest side of stackable accommodation parts 210 (when there are a plurality of stackable accommodation parts 210), and provided with a second space 221 to which air and a nutrient solution are supplied; a solution pipe part 230 disposed on one side of the stackable accommodation part 210, coupled to the solution supply line 300, and configured to supply a nutrient solution to the first space 213; an air supply part 240 disposed in the support part 220, coupled to the air supply line, and configured to supply air to the second space 221 of the support part 220; and a filter part 250 disposed between the stackable accommodation part 210 and the support part 220, and configured to separate the first space 213 and the second space 221 from each other and to prevent the soil in the first space 213 from being discharged to the second space 221. In this case, a space into which the first space 213 and the second space 221 are combined may be defined as the above-described cultivation space. When a plurality of stackable accommodation parts 210 are stacked on top of each other, a space into which pluralities of first spaces 213 and second spaces 221 are combined may be defined as a cultivation space. The plurality of first spaces 213 are also defined and described as the first space 213 below.

The stackable accommodation part 210 is a means that may be coupled to another stackable accommodation part 210 in the vertical direction or may be coupled to the support part 220 in order to place soil and plant crops therein. The stackable accommodation part 210 may include: a case portion 211 formed in a box shape (a rectangular box shape in the drawing) with an open top and bottom, and configured to form the first space 213; and a coupling portion 212 bent to be stepped from the bottom of the case portion 211 toward the center of the case portion 211, bent to extend downward again, and configured to be coupled to the top of the case portion 211 or to the top of the support part 220. That is, the coupling portion 212 is formed to have a section that is narrower than the top surface of the case portion 211, so that the coupling portion 212 can be fitted into the top of the case portion 211. Accordingly, the stackable accommodation parts 210 may be stacked on top of each other because the case portions 211 are disposed on upper sides and the coupling portions 212 are disposed under the case portions 211.

Furthermore, the stackable accommodation part 210 may be provided with support portions 215 that are bent and extend to both sides at the top. The support portions 215 are means that are supported by the crane 400, which will be described later. The stackable accommodation part 210 of the cultivation module 200 may be transferred to a desired location through the support portions 215. In addition, the support portions 215 are bent and extend to both sides at the top of the case portion 211, so that, when the stackable accommodation parts 210 are stacked on top of each other, the coupling portions 212 can be stably supported.

Furthermore, first solution coupling portions 214 configured to allow portions of the solution pipe part 230, to be described later, to be coupled thereto may be further provided on the other side of the stackable accommodation part 210. In more detail, the first solution pipe coupling portions 214 are means that allow the solution pipe part 230 to be selectively coupled thereto. The first solution pipe coupling portions 214 may be formed in a ring or hook shape for fitting the solution pipe part 230 on one side of the stackable accommodation part 210. There is no limitation to a coupling method. In addition, the first solution pipe coupling portions 214 are disposed on the other side of the stackable accommodation part 210. Accordingly, the solution pipe part 230 to be coupled to the first solution pipe coupling portions 214 does not interfere even when the stackable accommodation part 210 is transferred to one side by the crane 400, so that there is the effect of allowing the stackable accommodation part 210 to be easily transferred to the outside.

The support part 220 may be formed as a support structure that allows the stackable accommodation part 210 to be seated thereon by fitting the lower side of the stackable accommodation part 210, more specifically the coupling portion 212 of the stackable accommodation part 210, into the top thereof. In this case, the top of the support part 220 has the same size as the top of the case portion 211 of the stackable accommodation part 210, so that the coupling portion 212 of the stackable accommodation part 210 described above can be fitted into the top of the support part 220. The support part 220 may include an inclined surface 222 configured such that the bottom thereof is formed to be inclined toward the other side so that the vertical width of the second space 221 becomes wider toward one side, and a solution discharge outlet 223 disposed at the lower end of the other side of the inclined surface 222 and connected to a solution discharge flow path.

The inclined surface 222 is the bottom surface of the support part 220. The inclined surface 222 is a means that is inclined downward toward the other side, thereby allowing the nutrient solution, discharged from the soil, to flow to the other side by means of gravity. In this case, the lower end surface of the support part 220 may be formed as a flat surface, and only the bottom surface formed in the second space 221 may be inclined to the other side. This is intended to allow the support part 220 to be placed in the horizontal direction on a support surface when the support part 220 is loaded into the loading space 110 of the shelf case 100

Furthermore, the solution discharge outlet 223 is a means that is formed in an opening shape in the bottom of the other side of the inclined surface 222, i.e., the lowest portion of the bottom surface of the inclined surface 222, and is connected to the solution discharge line so that the nutrient solution discharged from the soil can be discharged into the solution discharge line. As the solution discharge outlet 223 is disposed in the lower end of the other side of the inclined surface 222, the nutrient solution discharged from the soil may flow down to the bottom along the inclined surface 222 by means of gravity and then be discharged into the solution discharge line through the solution discharge outlet 223.

Furthermore, a second solution pipe coupling portion 224 configured to allow a solution supply line 300, to be described later, to be coupled thereto may be disposed at the other end of the support part 220. In more detail, the second solution pipe coupling portion 224 is a means that allows one end of the solution supply line 300 to be selectively coupled thereto. The second fluid coupling portion 224 may be formed in a ring or hook shape for fitting the solution supply line 300 on one side of the support part 220, and there is no limitation to a coupling method. In addition, the second solution pipe coupling portion 224 is disposed at the other end of the support part 220, and is arranged to be parallel with the first solution coupling portions 214 in the vertical direction when the stackable accommodation part 210 is seated. There are the effects in which the solution pipe part 230 to be coupled to the first solution pipe coupling portions 214 is easily coupled to the solution supply line 300, and at the same time, the liquid pipe part 230 does not interfere even in the case where the stackable accommodation part 210 is transferred to one side by the crane 400.

The solution pipe part 230 is a means that is connected to the solution supply line 300 and provides a flow path for supplying a nutrient solution to the first space 213. The solution pipe part 230 may include: a first solution pipe flow path 231 connected to one end of the solution supply line 300 at one end thereof and configured to allow a nutrient solution to be introduced thereinto; a solution pipe spray flow path 233 bent or branched to spray the nutrient solution, introduced from the first solution pipe flow path 231, toward the upper side of the first space 213; and a second solution pipe flow path 232 disposed between the first solution pipe flow path 231 and the solution pipe spray flow path 233 to connect the first solution pipe flow path 231 and the solution pipe spray flow path 233, thereby providing the nutrient solution, introduced into the first solution pipe flow path 231, to the solution pipe spray flow path 233. In this case, the first solution pipe flow path 231, solution pipe spray flow path 233, and second solution pipe flow path 232 of the pipe fluid portion 230 may be arranged to be selectively coupled to each other or separated from each other.

The first solution pipe flow path 231 is a means that is coupled to the solution supply line 300 and allows a nutrient solution to be introduced from the solution supply line 300. A packing 231a may be formed at one end of the first solution pipe flow path 231. In this case, the packing 231a has a plurality of multi-stage portions spaced downward, thereby providing the effect of preventing the nutrient solution, introduced from the solution supply line 300, from being discharged to the outside.

Furthermore, when the stackable accommodation part 210 is transferred upward and separated from the support part 220 with the first solution pipe flow path 231 being coupled to the first solution pipe coupling portion 214 formed on the first solution pipe flow path 231 210, the first solution pipe flow path 231 is separated from the solution supply line 300. In contrast, when the stackable accommodation part 210 is coupled to the support part 220 again, the first solution pipe flow path 231 is coupled to the solution supply line 300 and thus receives a nutrient solution because the first solution pipe flow path 231 is coupled to the first solution pipe coupling portion 214. Accordingly, even when the stackable accommodation part 210 is re-seated on the support part 220 after transfer, there is the effect of ensuring that a nutrient solution is efficiently supplied to the cultivation space.

The second solution pipe flow path 232 is a means that extends a flow path for a nutrient solution in such a manner that one end thereof is coupled to the other end of the first solution pipe flow path 231 and the other end thereof is coupled to one end of the solution pipe spray flow path 233. In more detail, when the plurality of stackable accommodation parts 210 of a plurality of cultivation modules 200 are stacked on top of each other, one or more second solution pipe flow paths 232 may be arranged to adjust the length of a flow path according to the vertical length of the cultivation modules 200. When a plurality of second solution pipe flow paths 232 are connected to each other, the second solution pipe flow paths 232 may be combined and extend in the vertical direction. In other words, the second solution pipe flow path 232 may be utilized as a modular means that can adjust the length of the solution pipe part 230 depending on the situation where the stackable accommodation parts 210 are stacked on top of each other.

The solution pipe spray flow path 233 is a means that sprays the nutrient solution from the top portion of the cultivation space of the cultivation module 200, more specifically the top portion of the first space 213, into the first space 213. In more detail, the solution pipe spray flow path 233 is bent toward the top portion of the first space 213 with one end thereof coupled to the other end of the second solution pipe flow path 232, and may be branched in the bent state as needed so that the other end thereof can be disposed in the top portion of the first space 213. Furthermore, a spray hole may be formed at the other end of the solution pipe spray flow path 233 to spray the nutrient solution toward the top portion of the first space 213. In this case, the spray hole may be shaped to become narrower toward the other end thereof. However, there is no limitation to the shape of the spray hole as long as it is shaped to spray the nutrient solution.

The air supply part 240 is a means that is disposed in the support part 220, is connected to an air supply line, and supplies air to the second space 221 inside the support part 220. In more detail, the air supply part 240 may include: an air supply inlet 241 formed in an opening shape, disposed on the other side of the support part 220, and connected to the air supply line; and an air supply pipe configured to form a ring-shaped flow path along the inner surface of the support part 220 in order to supply the air, introduced from the air supply inlet 241, evenly throughout the area of the second space 221 and at the same time, to prevent the nutrient solution and the like from leaking to the outside from the second space 221, and provided with a plurality of pores. With the above configuration, the air supplied from the air supply line may be evenly supplied to the second space 221 through the air supply pipe through the air supply inlet 241. Additionally, air may be supplied to the soil in the first space 213 by air pressure attributable to the supply of air. Accordingly, there is the effect of efficiently performing root respiration as needed.

The filter part 250 is a means that is disposed between the stackable accommodation part 210 and the support part 220, separates the first space 213 of the stackable accommodation part 210 and the second space 221 of the support part 220 from each other, prevents the soil in the first space 213 from flowing into the second space 221, and also filters the nutrient solution supplied to the first space 213 or discharged to the second space 221. In more detail, the filter part 250 may include: a filter net 251 having a section corresponding to the sections of the first space 213 and the second space 221 and provided with minute pores formed therein; and filter supports 252 disposed outside the filter net 251 and configured to support the filter net 251. The filter net 251 may be securely fixed by the filter supports 252 despite the pressure of the nutrient solution that is discharged from the first space 213 to the second space 221.

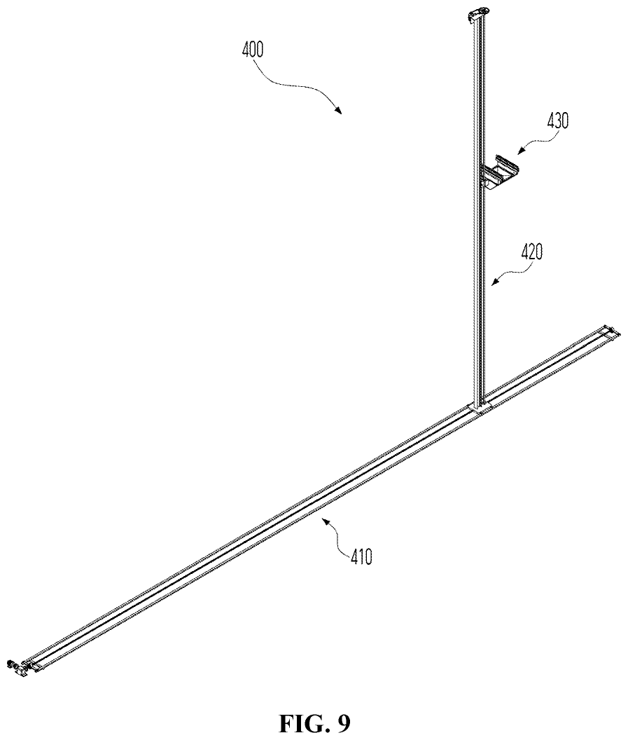

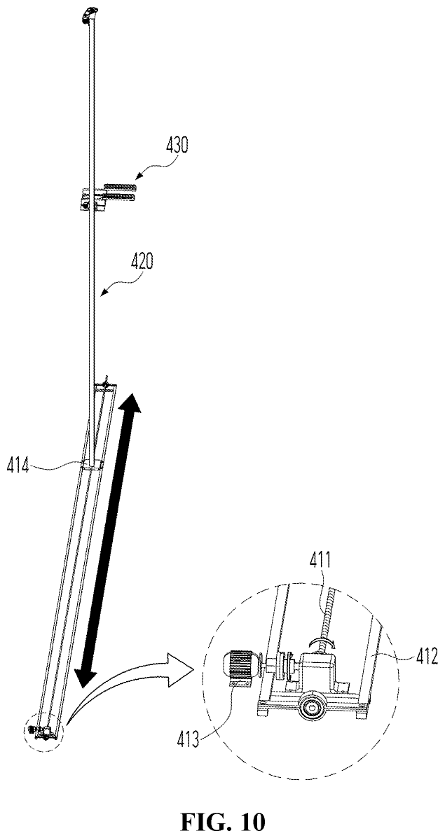

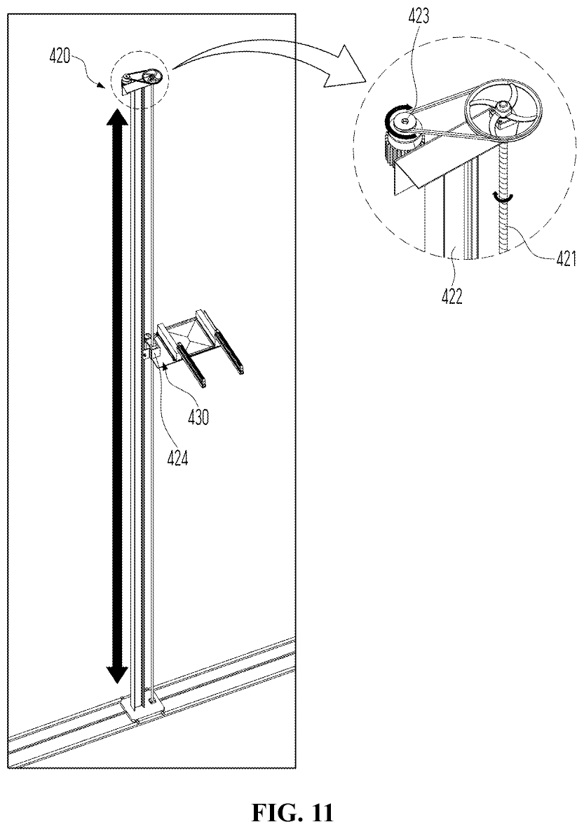

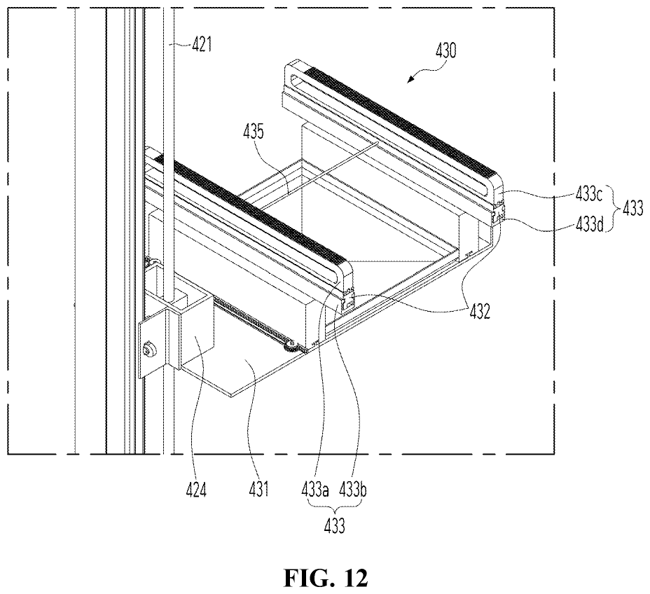

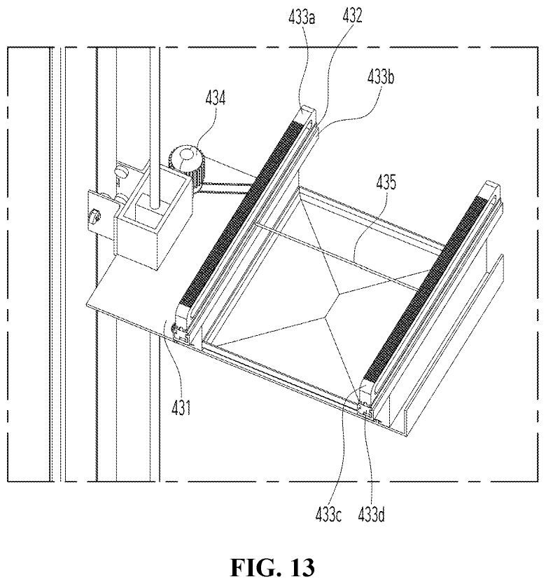

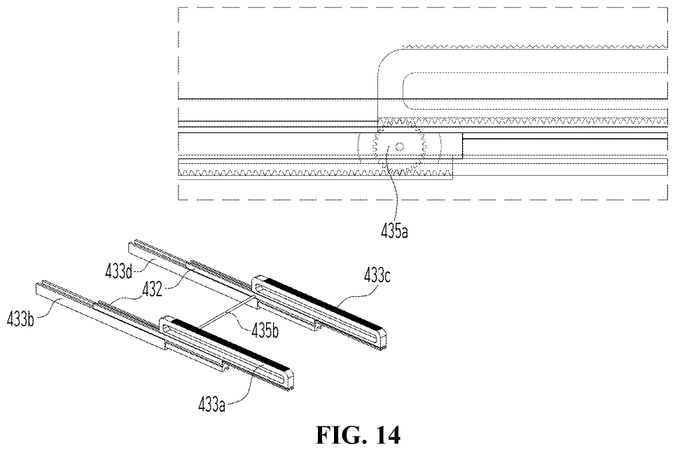

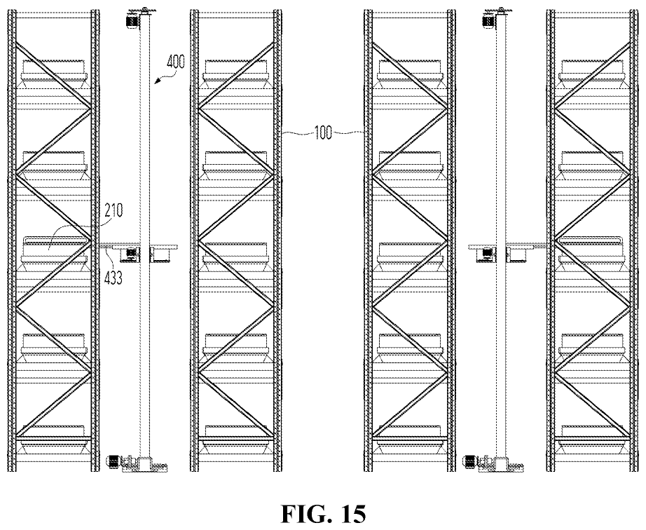

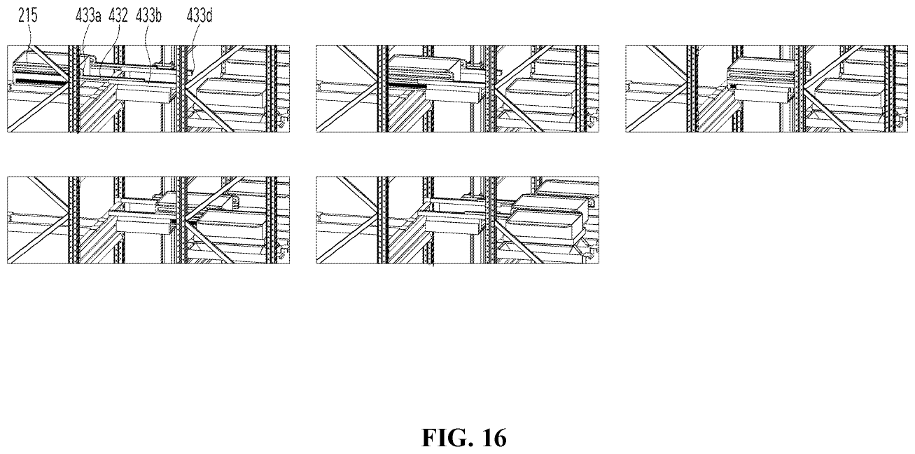

FIG. 9 is a perspective view showing the crane of the crop cultivation apparatus according to the embodiment of the present invention, FIG. 10 is a view showing the operation of the horizontal part of the crane of the crop cultivation apparatus according to the embodiment of the present invention, FIG. 11 is a view showing the operation of the vertical part of the crane of the crop cultivation apparatus according to the embodiment of the present invention, FIG. 12 is a perspective view showing the transfer part of the crane of the crop cultivation apparatus according to the embodiment of the present invention from one side, FIG. 13 is a perspective view showing the transfer part of the crane of the crop cultivation apparatus according to the embodiment of the present invention from the other side, FIG. 14 is a view showing the principle by which the transfer supports of the transfer part of the crane of the crop cultivation apparatus according to the embodiment of the present invention are operated, FIG. 15 is a view showing the operation of the crane based on shelf cases in the crop cultivation apparatus according to the embodiment of the present invention, and FIG. 16 is a diagram showing a process in which the transfer part of the crane transfers a stackable accommodation part placed in a loading space of the crop cultivation apparatus according to the embodiment of the present invention.

Referring to FIGS. 9 to 16, the crop cultivation apparatus using the stackable cultivation modules and the crane 400 according to the embodiment of the present invention may further include the crane 400 configured to transfer the stackable accommodation parts of the cultivation modules and a control unit configured to control the crane 400.

When a plurality of shelf cases are disposed, one crane 400 may be disposed between the shelf cases. As an example, cranes 400 may be disposed such that one crane 400 is disposed between two shelf cases. However, it should be noted that this configuration is only an example and the present invention is not limited thereto. The configuration of the crane 400 will be described in detail below.

The crane 400 may include: a transfer part 430 configured to support and transfer the stackable accommodation part of a cultivation module; a vertical part 420 configured to provide a vertical shaft 421 and vertical power for the vertical movement of the transfer part 430; and a horizontal part 410 configured to provide a horizontal shaft 411 and horizontal power for the front-rear movement of the transfer part 430.

The horizontal part 410 is a means that may extend in the direction in which the shelf case extends, i.e., along a length corresponding to the width of the loading spaces for the loading of the shelf case, and horizontally transfer the stackable accommodation part of the cultivation module along the extension direction. In more detail, the horizontal part 410 may include: a horizontal rail 412 extending from one side of the shelf case to a set length in the horizontal direction along the horizontal extension direction of the shelf case, and configured to guide a target in the horizontal direction for horizontal movement; a horizontal shaft 411 disposed on one side of the horizontal rail 412, disposed to extend along the direction in which the horizontal rail 412 extends, provided with threads formed on the outside thereof, and rotatably disposed; a horizontal power unit 413 connected to the horizontal shaft 411 and configured to transmit rotational power to rotate the horizontal shaft 411; and a horizontal transfer part 414 configured such that the vertical part 420 is disposed thereon, connected to the horizontal shaft 411, and configured to be moved in the horizontal direction by the rotation of the horizontal shaft 411.

The horizontal rail 412 is a means that guides the vertical part 420 in the horizontal direction for the purpose of achieving the horizontal movement of the transfer part 430. In more detail, the horizontal rail 412 may be formed such that two rail shafts extend along both sides in a predetermined horizontal direction in parallel with each other, and the length over which the horizontal rail 412 extends in the horizontal direction may be determined depending on the length of the shelf case. The horizontal movement of the transfer part 430 is performed in such a manner that the vertical part 420 to be described later is moved along the direction in which the horizontal rail 412 extends.

The horizontal shaft 411 may be formed in a shaft shape that extends along the center portion of the horizontal rail 412 in the direction in which the horizontal rail 412 extends. In this case, threads may be formed on the outside of the horizontal shaft 411. The horizontal shaft 411 is arranged such that one end thereof is connected to the horizontal power unit 413 and thus it is rotated by received horizontal power. In this case, the horizontal shaft 411 is only rotated in a fixed state.

The horizontal power unit 413 is a means that is connected to the horizontal shaft 411 and transmits horizontal power to rotate the horizontal shaft 411. In more detail, the horizontal power unit 413 may include a horizontal motor configured to generate horizontal power for rotation, and horizontal gears connected to the horizontal motor and configured to rotate the horizontal shaft 411 by changing the direction of horizontal power. The horizontal gears may be formed as a belt or gear type of mechanism. It should be noted that there is no limitation to the implementation of the horizontal gears as long as power transmission is possible.

The horizontal transfer part 414 is a means that is formed in a plate shape, allows the vertical shaft 421 to be seated thereon, and is coupled to the horizontal shaft 411 so that it is moved in the horizontal direction when the horizontal shaft 411 rotates. In more detail, the horizontal transfer part 414 may have a through hole that is formed through one side of the plate thereof and allows the horizontal shaft 411 to pass therethrough and be coupled thereinto. Additionally, threads corresponding to the threads formed on the outer surface of the horizontal shaft 411 are formed inside the through hole of the horizontal transfer part 414. Accordingly, the horizontal transfer part 414 is a means that moves the vertical shaft 421 horizontally in such a manner as to move in the horizontal direction when the horizontal shaft 411 is rotated in the state of being fixed in place.

The vertical part 420 is a means that may extend in the height direction of the shelf case, i.e., to a length corresponding to the vertical height of the loading space for the loading of the shelf case, and vertically transfers the stackable accommodation part of the cultivation module along the vertical direction in which the vertical part 420 extends. In more detail, the vertical part 420 may include: a vertical rail 422 seated on the top of the horizontal part 410, more specifically the top of the horizontal transfer part 414 of the horizontal part 410, extending to a set length in the vertical direction according to the height of the shelf case, and configured to guide vertical movement in the vertical direction; a vertical shaft 421 disposed along one side of the vertical rail 422, extending along the direction in which the vertical rail 422 extends, provided with threads formed on the outside thereof, and rotatably disposed; a vertical power unit 423 connected to the vertical shaft 421, and configured to transmit rotational power to rotate the vertical shaft 421; and a vertical transfer part 424 connected to the transfer part 430 and configured to be moved in the vertical direction by the rotation of the vertical shaft 421.

The vertical rail 422 is a means that guides the vertical movement of the transfer part 430 for the purpose of performing the vertical movement of the transfer part 430. In more detail, the vertical rail 422 may be formed as a single shaft that extends to one side in a predetermined vertical direction, and the length to which the vertical rail 422 extends in the vertical direction may be determined depending on the vertical height of the shelf case. The transfer unit 430 to be described later may move vertically along the direction in which the vertical rail 422 extends.

The vertical shaft 421 may have an axial shape that extends in parallel along one side of the vertical rail 422 in the direction in which the vertical rail 422 extends. In this case, threads may be formed on the outside of the vertical shaft 421. The vertical shaft 421 is disposed such that one end thereof is connected to the vertical power unit 423 and it is rotated by received vertical power. In this case, the vertical shaft 421 may be only rotated in a fixed state.

The vertical power unit 423 is a means that is connected to the vertical shaft 421 and transmits vertical power to rotate the vertical shaft 421. In more detail, the vertical power unit 423 may include: a vertical motor configured to generate vertical power for rotation; and vertical gears connected to the vertical motor and configured to rotate the vertical shaft 421 by changing the direction of the vertical power. The vertical gears may be formed as a belt or gear type mechanism. There is no limitation as long as power transmission is possible.

The vertical transfer part 424 is a means that is disposed in a plate shape so that the transfer part 430 can be seated on the top thereof and is coupled to the vertical shaft 421 so that it can be moved vertically as the vertical shaft 421 rotates. In more detail, the vertical transfer part 424 may have a through hole that is formed through one side of the plate thereof and allows the vertical shaft 421 to pass therethrough and be coupled thereinto. Threads corresponding to the threads formed on the outer surface of the vertical shaft 421 may be formed inside the through hole. When the vertical shaft 421 is rotated in the state of being fixed in place, the vertical transfer part 424 is moved in the vertical direction, so that the transfer unit 430 is moved vertically.

The transfer part 430 is a means that is operated to support and transfer the stackable accommodation part of the cultivation module in the state of being seated on the vertical part 420. In more detail, the transfer part 430 may include: a base part 431 coupled to the vertical part 420 and configured to provide a support space for the seating and supporting of the stackable accommodation part; transfer rails 432 disposed on both sides of the top of the base part 431, extending to one side in parallel with each other, and configured to guide the stackable accommodation part in the separation direction by separating the stackable accommodation part in the extension direction; transfer supports 433 disposed on the respective tops of the transfer rails 432, disposed to be movable to one side or the other side along the direction in which the transfer rails 432 extend, and configured to transfer the stackable accommodation part while supporting the stackable accommodation part on the top thereof; a transfer power unit 434 configured to provide transfer power for the movement of the transfer supports 433 to one side and the other side; and a transfer power transmission part 435 configured to transmit transfer power to the transfer supports 433.

The base part 431 is a means that is fixedly coupled to one side of the vertical part 420, more specifically one side of the vertical transfer part 424 of the vertical part 420, and forms a support space in which the stackable accommodation part is transferred horizontally and vertically in the state of being seated and supported by the transfer supports 433. In more detail, the base part 431 is formed in a plate shape, and the stackable accommodation part may be supported and inserted by the support space on the top surface of the base part 431.

The transfer rails 432 are means that are arranged to extend in parallel with each other on both sides of the base part 431 and guide the stackable accommodation part in the separation direction when the stackable accommodation part is separated from the loading space. In more detail, the transfer rails 432 may be formed as two rails parallel to each other on both sides of the base part 431. In this case, the width between the two rails is formed to correspond to the front width of the stackable accommodation part so that a space into which the stackable accommodation part is inserted can be formed. In addition, the transfer supports 433 are movably coupled to the tops of the transfer rails 432, so that the transfer rails 432 can guide the transfer supports 433 in the movement direction. In this case, the two transfer rails 432 may be defined as a first transfer rail 432 and a second transfer rail 432, respectively.

The transfer supports 433 are means that are disposed on one or more of the top and bottom sides of the transfer rails 432, extend in the transfer direction of the transfer rails 432, and can be moved in one or the other direction parallel to the transfer direction. The transfer supports 433 may be formed as two supports parallel to each other on the top sides of the two rails of the transfer rails 432, and may extend and move to one side or the other side along the direction in which the transfer rails 432 extend.

The transfer supports 433 may include first transfer supports 433a and 433c disposed on the tops of the transfer rails 432 and second transfer supports 433b and 433d disposed on the bottoms of the transfer rails 432. In this case, the length to which the first transfer supports 433a and 433c and the second transfer supports 433b and 433d extend may be formed to be a length corresponding to the length to which the transfer rails 432 extend. When transfer power is transmitted to the first transfer supports 433a and 433c and the second transfer supports 433b and 433d for the purposed of performing transfer, the first transfer supports 433a and 433c and the second transfer supports 433b and 433d may be moved in opposite directions with respect to the transfer rails 432. The transfer process of the transfer supports 433 will be described in more detail.

The first transfer supports 433a and 433c are means that are disposed on the tops of the transfer rails 432, have anti-slip portions formed on the top surfaces thereof to support the stackable accommodation part and a plurality of gear teeth formed on the inner surfaces thereof along the extension direction, and can be moved to one side or the other side along the extension direction of the transfer rails 432 by the transfer power transmission part 435 to be described later. In more detail, the first transfer supports 433a and 433c include a first-first transfer support 433a disposed on the top of the first transfer rail 432, and a first-second transfer support 433c disposed on the top of the second transfer rail 432.

The second transfer supports 433b and 433d are disposed on the bottoms of the transfer rails 432 and may be fixedly coupled to both sides of the top surface of the base part 431. In addition, the second transfer supports 433b and 433d may each have a plurality of gear teeth formed along the inner surface thereof in the extending direction, and are means that may move the transfer rails 432 to one side or the other by means of the transfer power transmission part 435 to be described later. In this case, although the transfer rails 432 are described as being moved, the transfer rails 432 are only used as means for guiding movement in the transfer direction in reality, but there is the effect in which the transfer rails 432 are moved in the opposite direction because the second transfer supports 433b and 433d are fixed to both sides of the top surface of the base part 431. The second transfer supports 433b and 433d may include a second-first transfer support 433b disposed on the bottom of the first transfer rail 432, and a second-second transfer support 433d disposed on the bottom of the second transfer rail 432.

The transfer power unit 434 is a means that provides transfer power for the movement of the transfer support 433. In more detail, the transfer power unit 434 is a means that is disposed on one side of the transfer supports 433 and transmits transfer power to the transfer supports 433 through the transfer power transmission part 435 to be described later. A motor may be used as the transfer power unit 434. However, it should be noted that the transfer power unit 434 is not limited thereto, but any device may be used as the transfer power unit 434 as long as it can generate power.

Furthermore, the transfer power unit 434 may generate transfer power in both forward and reverse directions to allow the transfer support 433 to move in both directions.

The transfer power transmission part 435 is a means that transmits the transfer power, generated by the transfer power unit 434, to the transfer supports 433. In more detail, the transfer power transmission part 435 is rotated by transfer power, and may include a transfer shaft 435b connecting transfer gears 435a disposed on the first transfer rail 432 and the second transfer rail 432, respectively, to each other.

The transfer gears 435a are circular gears each having gear teeth formed on the outer peripheral surface thereof, and may be arranged such that the gear teeth formed on the outer peripheral surfaces thereof engage with the gear teeth formed on the first transfer supports 433a and 433c and second transfer supports 433b and 433d of the transfer supports 433. In more detail, the transfer gears 435a may include a first transfer gear 435a disposed on the first transfer rail 432 and a second transfer gear 435a disposed on the second transfer rail 432.

The first transfer gear 435a may be installed to the first transfer rail 432, and may be disposed between the first-first transfer support 433a and the second-first transfer support 433b so that the gear teeth formed on the outer peripheral surface thereof engage with the gear teeth formed on the first-first transfer support 433a and the gear teeth formed on the second-first transfer support 433b.

The second transfer gear 435a may be installed to the second transfer rail 432, and may be disposed between the first-second transfer support 433c and the second-second transfer support 433d so that the gear teeth formed on the outer peripheral surface thereof engage with the gear teeth formed on the first-second transfer support 433c and the gear teeth formed on the second-second transfer support 433d.

Furthermore, the first transfer gear 435a may be directly connected to the transfer power unit 434 and rotated by the rotation of the transfer power unit 434. The second transfer gear 435a may be rotated at the same speed as the first transfer gear 435a when the transfer shaft 435b is rotated by the rotation of the first transfer gear 435a.

Furthermore, the transfer shaft 435b is fixedly coupled through the centers of the transfer gears 435a, and is rotated by transfer power. In more detail, the transfer shaft 435b is a means that forms the central shaft of the first transfer gear 435a and the second transfer gear 435a in such a manner that one end of the transfer shaft 435b is coupled into the center of the first transfer gear 435a and the other end of the transfer shaft 435b is coupled into the center of the second transfer gear 435a at the other end. In this case, as the first transfer gear 435a is rotated by the transfer power unit 434, the transfer shaft 435b may also be rotated. Additionally, the second transfer gear 435a may also be rotated by the rotation of the transfer shaft 435b at the same speed and in the same direction as the transfer gear 435a.

The control unit is a means that transfers the stackable accommodation part of the cultivation module through the control of the crane 400. In more detail, in the state in which the coordinates of the support portions of a stackable accommodation part (the lowest stackable accommodation part when there are a plurality of stackable accommodation parts) located directly above the support part of each cultivation module have been stored as set coordinates for each cultivation module, when a user inputs a control signal adapted to transfer a stackable accommodation part to a desired location through the control unit, the control unit may control the crane 400 so that the transfer unit 430 is transferred to the coordinates that are selected from the set coordinates and match the control signal. In other words, the control unit is a control means that transfers the stackable accommodation part at a specific location to a desired target location by controlling the power units (the horizontal power unit 413, the vertical power unit 423, and the transfer power unit 434) of the crane 400.

The operation of the crop cultivation apparatus equipped with a crane for moving cultivation modules according to the embodiment of the present invention will be described in detail below.

In the state in which cultivation modules are placed in the loading spaces of the shelf case, a user may input a control signal adapted to transfer a stackable accommodation part at a desired location to the control unit. The control unit may match the input control signal against the set coordinates and control the crane 400 to transfer the transfer unit 430 to selected coordinates. When the control unit controls the crane 400, the crane 400 operates as follows.

First, the horizontal part 410 of the crane 400 may be operated in the state of being disposed in a basic or final position. When the control unit operates the horizontal power unit 413, horizontal power is generated. Accordingly, as the horizontal shaft 411 is rotated, the horizontal transfer part 414 connected to the horizontal shaft 411 is moved horizontally in the direction in which the horizontal rail 412 extends, so that the vertical part 420 and the transfer part 430 may be moved horizontally in the X axis.

Thereafter, the vertical part 420 of the crane 400 may be operated. When the control unit operates the vertical power unit 423, vertical power is generated. Accordingly, as the vertical shaft 421 is rotated, the vertical transfer part 424 connected to the vertical shaft 421 is move vertically in the direction in which the vertical rail 422 extends, so that the transfer part 430 can be moved vertically in the Y axis.

Although the case where the vertical part 420 operates after the horizontal part 410 operates has been described as an example, the horizontal part 410 and the vertical part 420 may operate simultaneously such that vertical and horizontal movement can be achieved simultaneously as needed.

When the operations of the horizontal part 410 and the vertical part 420 have been completed, the control unit may operate the transfer power unit 434. Accordingly, when the transfer power is generated, the transfer gears 435a of the transfer power transmission unit 435 are rotated, so that the transfer supports 433 can be moved to be placed under the bottoms of the support portions of the stackable accommodation part of a cultivation module. The distance to which the transfer supports 433 are moved may vary depending on the arrangement of the shelf case. This may be adjusted via the first transfer supports 433a and 433c and the second transfer supports 433b and 433d by the operation of the transfer power unit 434 in the Z axis.

When the transfer supports 433 are placed under the bottoms of the support portions of the stackable accommodation part, the control unit may move the transfer part 430 upward to a set distance by controlling the vertical power unit 423 of the vertical part 420. Accordingly, the stackable accommodation part may be lifted in the state of being seated on the transfer supports 433.

The control unit may transfer the stackable accommodation part to a desired location by controlling the operations of the vertical power unit 423 and the horizontal power unit 413 in this state. In principle, the stackable accommodation part may be moved to a basic position. However, when the user selects a desired transfer position upon inputting a control signal, it may be possible to transfer the stackable accommodation part to another loading space accordingly.

In contrast, in order to transfer the stackable accommodation part from the basic position to the desired loading space, the above operation may be performed in reverse. A redundant description of this will be omitted.

The above-described crop cultivation apparatus equipped with a crane for moving cultivation modules according to an embodiment of the present invention has the following effects:

First, only the stackable accommodation part of the cultivation module placed in the crop cultivation apparatus may be transferred to the outside, so that there is the effect in which the stackable accommodation part can be easily transferred to the outside without interference with the separate solution supply line, the separate solution discharge line, and the separate air supply line that are fixed to the shelf case.

In particular, only the stackable accommodation part where crops are grown at the desired location may be transferred to the outside using the crane 400 without the need for a grower or harvester to manually climb up and down the shelf case using a ladder. Accordingly, there are the effects in which a high economic advantage is achieved due to a reduction in labor cost and safety-related accidents that may occur depending on a working environment are drastically decreased.

Furthermore, when there is a problem with the solution supply line, the solution discharge line, or the air supply line connected to the shelf case and thus the crops placed on a shelf need to be transferred to another shelf, the stackable accommodation part of the cultivation module may be easily transferred to the other shelf, so that there is the effect in which work time is drastically reduced.

Moreover, the horizontal part 410 of the crane 400 may be extended up to a processing line for harvesting and processing crops, and thus the harvesting and processing of crops may be performed in one stop, so that there are the effects in which harvest efficiency is improved and an overall process spanning from the cultivation of crops through the harvesting thereof to the processing thereof is automated in one process.

The present invention has been described so far with a focus on the exemplary embodiments. It will be understood by those of ordinary skill in the art to which the present invention pertains that the present invention may be implemented in a modified form without departing from the essential features of the present invention. Therefore, the disclosed embodiments should be taken into consideration in an illustrative sense rather than a restrictive sense. The scope of the present invention is defined based on the attached claims rather than the foregoing detailed description, and all differences falling within the scopes equivalent to the claims should be construed as being included in the present invention.

What is claimed is:

1. A crop cultivation apparatus comprising:
a shelf case composed of one or more layers, extending to one side, and provided with loading spaces formed in the respective layers;
one or more stackable accommodation parts disposed in each of the loading spaces of the shelf case, and configured to provide a first cultivation space for cultivating soil crops therein, and arranged to be stackable in a vertical direction;
a support part seated on the shelf case, and configured to allow the stackable accommodation parts to be seated thereon and to provide a second space from which a nutrient solution is discharged and to which air is supplied; and
a crane disposed in front of the shelf case, and configured to transfer each of the stackable accommodation parts;
wherein the crane transfers the stackable accommodation part in vertical and horizontal directions after separating the stackable accommodation part from the loading space.

2. The crop cultivation apparatus of claim 1, wherein the crane includes:
a horizontal part extending in a direction in which the shelf case extends, and configured to generate horizontal power and to horizontally transfer the stackable accommodation part;
a vertical part extending upward from the horizontal part, and configured to generate vertical power and to vertically transfer the stackable accommodation part; and
a transfer part disposed on the vertical part, and configured to generate transfer power and to separate the stackable accommodation part from the loading space;
wherein the vertical part is horizontally movable along a direction in which the horizontal part extends; and
wherein the transfer part is vertically movable along a direction in which the vertical part extends.

3. The crop cultivation apparatus of claim 2, wherein the horizontal part includes:
a horizontal rail extending to both sides, and configured to guide horizontal movement in the horizontal direction;
a horizontal shaft disposed on a central side of the horizontal rail along a direction in which the horizontal rail extends, and provided with threads formed on an outside thereof;
a horizontal power unit configured to provide horizontal power to rotate the horizontal shaft; and
a horizontal transfer part provided with threads that correspond to the threads of the horizontal shaft and are formed on an inside thereof, coupled to the horizontal shaft, and configured to allow the vertical part to be disposed on a top thereof;
wherein the horizontal part is disposed such that, when the horizontal power is provided, the vertical part is moved in the horizontal direction while the horizontal transfer part is moved in the horizontal direction along a direction in which the horizontal rail extends by rotation of the horizontal shaft.

4. The crop cultivation apparatus of claim 2, wherein the vertical part includes:
a vertical rail extending vertically, and configured to guide vertical movement in the horizontal direction;
a vertical shaft disposed on one side of the vertical rail along a direction in which the vertical rail extends, and provided with threads formed on an outside thereof;
a vertical power unit configured to provide vertical power to rotate the vertical shaft; and
a vertical transfer part provided with threads that correspond to the threads of the vertical shaft and are formed on an inside thereof, coupled to the vertical shaft, and configured to allow the transfer unit to be coupled to one side thereof;
wherein the vertical part is disposed such that, when the vertical power is provided, the transfer part is moved up and down in the vertical direction while the vertical transfer part is moved vertically in a direction in which the vertical rail extends by rotation of the vertical shaft.

5. The crop cultivation apparatus of claim 2, wherein the transfer part includes:
a base part coupled to the vertical part, and configured to provide a support space for supporting the stackable accommodation part;
transfer rails disposed on both sides of the base part, extending to one side, and configured to guide the stackable accommodation part in a separation direction;
transfer supports disposed on the transfer rails, disposed to be movable to one side or a remaining side along a direction in which the transfer rails extend, and configured to support both sides of the stackable accommodation part on tops thereof and to transfer the stackable accommodation part;
a transfer power unit configured to provide transfer power to move the transfer supports; and
a transfer power transmission part configured to transmit the transfer power, generated by the transfer power unit, to the transfer supports.

6. The crop cultivation apparatus of claim 5, wherein the transfer supports include:
first transfer supports disposed on tops of the transfer rails; and
second transfer supports disposed on bottoms of the transfer rails, and coupled to a top surface of the base part.

7. The crop cultivation apparatus of claim 6, wherein the transfer power transmission part includes:
transfer gears provided with gear teeth formed on outer peripheral surfaces thereof that engage with gear teeth formed on inner surfaces of the first and second transfer supports; and
a transfer shaft formed in a shaft form that connects centers of the transfer gears to each other;
wherein, when the transfer power unit generates transfer power, all the transfer gears are rotated by the transfer shaft.

8. The crop cultivation apparatus of claim 2, further comprising a control unit configured to control the horizontal part, the vertical part, and the transfer part;
wherein set coordinates are stored for each disposition position of each stackable accommodation part in the loading space, and the control unit, when a user inputs a control signal, controls the vertical part, the horizontal part, and the transfer part so that the stackable accommodation part can be transferred to a location corresponding to set coordinates that match the control signal.
